(19) United States
(12) Patent Application Publication
(10) Pub. No.: US 2008/0274367 A1
(43) Pub. Date: Nov. 6, 2008

(54) RECOVERED HIGH STRENGTH MULTI-LAYER ALUMINUM BRAZING SHEET PRODUCTS

(75) Inventors: Raymond J. Kilmer, Birmingham, MI (US); John F. Butler, Lititz, PA (US); Men Glenn Chu, Export, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(73) Assignee: ALCOA INC., Pittsburgh, PA (US)

(21) Appl. No.: 12/123,760

(22) Filed: May 20, 2008

Related U.S. Application Data
(63) Continuation-in-part of application No. 11/248,531, filed on Oct. 12, 2005, now Pat. No. 7,374,827.
(60) Provisional application No. 60/618,637, filed on Oct. 13, 2004.

(51) Int. Cl. B32B 15/01; B21C 37/00

(52) U.S. Cl. 428/607; 428/654

(57) ABSTRACT

A multi-layer metallurgical product comprising a core aluminum alloy, purposefully tailored through chemistry and processing route to resist recrystallization during the brazing cycle to intentionally exploit the higher strengths immediately after brazing of a deformed and recovered microstructure, the core aluminum alloy being positioned on one side to an aluminum alloy interliner designed to be resistant to localized erosion, which, in turn, is adjacent to a 4xxx cladding alloy. The multi-layer product can be fabricated at least in part via any multi-alloy ingot casting processes such as the Simultaneous Multi-Alloy Casting process or the Unidirectional Solidification of Castings process.

### CROSS REFERENCE TO RELATED APPLICATION

The present invention claims benefit of U.S. patent application Ser. No. 11/248,531 (now U.S. Pat. No. 7,374,827), entitled: “RECOVERED HIGH STRENGTH MULTI-LAYER ALUMINUM BRAZING SHEET PRODUCTS” filed on Oct. 12, 2005, which claims benefit of U.S. Provisional Application Ser. No. 60/618,637, entitled: “RECOVERED HIGH STRENGTH MULTI-LAYER ALUMINUM BRAZING SHEET PRODUCTS” filed on Oct. 13, 2004, which are both incorporated herein by reference.

### FIELD OF THE INVENTION

This invention relates to the field of heat treatable and non-heat treatable aluminum, alloy products. In particular, this invention relates to multi-layer brazing sheet products and processes for manufacturing these brazing sheet products. More particularly, the present invention is directed to a brazing sheet product useful for high-strength applications such as heat exchangers.

### BACKGROUND OF THE INVENTION

There is an increasing need for the reduction of weight and the reduction in cost for products made from aluminum brazing sheet, particularly for brazing sheet used in heat exchangers, particularly in automotive applications. Brazing sheet products that exhibit higher-post braze yield strengths are desirable, as these high-strength products allow automotive engineers to downgauge. In short, a high strength brazing sheet product would allow the heat exchanger to be made from a thinner and, therefore, lighter brazing sheet, with corresponding weight savings in the overall automotive design.

In addition, it is equally important that the brazing sheet or plate product have adequate corrosion resistance as well as adequate brazeability to allow the heat exchanger manufacturer to reliably braze the heat exchanger.

Ideally, variants of the products also must be brazeable by a variety of brazing methods, most notably, vacuum and flux-based (e.g. CAB or Nocolok™) brazing processes, to have as wide an application as possible.

Although products which exhibit a recovered, but not recrystallized, microstructure are highly desirable from a post-braze yield strength perspective, it is well known that these microstructures are highly susceptible to localized erosion during the brazing cycle. Non-homogenized 3xxx cores, in O-temper, are known to be sensitive to core erosion during brazing. Core erosion is localized melting of the core alloy in contact with the molten 4xxx cladding and generally is deleterious to corrosion resistance and cladding flow (i.e., brazeability). Localized erosion typically results from enhanced Si diffusion from the 4xxx cladding alloy into the underlying base metal in contact with the 4xxx cladding alloy. The dislocation networks (e.g., sub-grain boundaries) present in recovered, but unrecrystallized, microstructures result in demonstrably higher diffusivities for Si. The enhanced mobility of Si in the presence of a fine network of interlacing dislocations results in high local Si concentrations, which, in turn, result in localized melting of the metal in contact with the 4xxx cladding alloys during the brazing cycle. This localized melting of the core alloy enriches the cladding with aluminum, and changes in-situ the cladding alloy's composition and its flow properties. Localized melting can also alter the surface topography of the metal, which generally retards 4xxx cladding flow during the brazing cycle and results in poor brazeability. Lastly, this localized ingress of Si into the core can result in an increased susceptibility to localized corrosion.

### SUMMARY OF THE INVENTION

The present invention relates to a selection of core and cladding alloys, cladding thicknesses, and processing routes that, when combined, produce formable, corrosion-resistant aluminum brazing sheet alloy products which exhibit good brazeability, including good cladding flow, with surprisingly low incidence of localized erosion, and which display surprisingly high post-braze tensile strengths immediately after brazing. The invention additionally includes Mg-containing and Mg-free (i.e., less than 0.05 wt-%) variants of brazing sheet products, with differing arrangements and thicknesses of the layers (e.g., a core alloy layer, inter-liner layer, and a cladding layer, such as an Aluminum Association 4343 alloy cladding layer).

The invention is a metallurgical product consisting of, or consisting essentially of, a core aluminum alloy, purposefully tailored through chemistry and processing route to resist recrystallization during the brazing cycle to intentionally exploit the higher strengths immediately after brazing of a deformed and recovered microstructure, the core alloy being bonded on one side to an aluminum alloy inter liner designed to be resistant to localized erosion, which, in turn, is bonded to a 4xxx cladding alloy.

In one embodiment of the invention, the brazing sheets incorporate a non-homogenized core. The core alloy has a recovered, in contrast to a substantially or wholly recrystallized, microstructure. In another embodiment of the invention, both the core alloy and at least one of the outerliner layers have a recovered, non-homogenized microstructure.

An aspect of the invention is the presence of a high volume-fraction of fine particles that resist recrystallization in these alloys designed to exploit the higher strengths of a recovered microstructure. In dispersion-strengthened alloys (e.g., 3xxx alloys), it is generally desirable to avoid a homogenization practice to keep the volume-fraction of fine particles as high as possible. Careful selection (or purposeful avoidance) of the thermal practices is a factor in establishing the dispersoid volume fraction and distribution, so, too, is the selection of alloying levels and alloying elements. For example, specific alloying elements such as Zr will also retard recrystallization. A partially or fully recovered microstructure will be significantly stronger, particularly in terms of tensile yield strength, than a fully-recrystallized (annealed) microstructure.

In one aspect of the invention, the core alloy and the 4xxx alloy cladding are separated by an interliner, such that the core is bonded to an interliner that is resistant to erosion, and the interliner is, in turn, bonded to the 4xxx alloy. This structure minimizes localized erosion, promotes good brazeability, and, by suitable selection of the interliner alloy, enhances corrosion resistance, such that tire interliner alloy sacrificially protects the underlying core alloy.

A further aspect of the invention is that the core alloy and/or outerliner alloy is highly resistant to recrystallization, even in a highly strained, deformed state, during the brazing cycle. This deformation can be introduced naturally during the stamping, drawing, and/or forming operations used to make the parts or can be purpose fully introduced into the sheet by the aluminum sheet manufacturer.

A further aspect of the invention is a multi-alloy metallurgical product fabricated by a multi-layer casting process that overcomes the deficiencies of the hot roll bonding technology. The hot roll bonding technology has limitations in bonding dis-similar layers. There can be significant challenges in bonding layers with significantly different flow stresses and alloys that tend to oxidize at elevated temperatures and develop surface structures that are not conducive to bonding. These problems can result in complete loss of individual packages or decreased recovery from packages due to roll-off of individual layers resulting in layer clad ratios that are not within the target allowable range. In addition, asymmetric multi-layer packages can result in significant distortion during hot roll bonding causing the entire package to curl which can result in difficulty in manipulating the package and in feeding it into the gap of the rolling mill. In an extreme case it can result in damage to the rolling mill. In order to avoid these problems, but to still be able to generate the type of multi-layer packages that can benefit from, higher post-braze strength due to the recovered microstructure, multi-layer composites can be formed in whole or at least in part by casting the entire composite or at least part of the composite structure via casting technologies that can generate multi-layer ingots in which the various layers are already bonded together.

### DESCRIPTION OF THE DRAWINGS

FIG. 1 is a schematic diagram showing the distinct layers of the several variants of multi-layer brazing sheets. It may be appreciated that, for clad composites exhibiting more than one interlayer, the composition and/or cladding ratio of the second interlayer may differ from that of the first interlayer. Further, it may be appreciated that the cladding layer described as the outerliner may consist of a brazing cladding or may consist of a waterside cladding or other aluminum cladding alloy;

FIG. 2 is a table (Table 1) showing the compositions (wt-%) of the core, brazing cladding, and interliner alloys used for the laboratory-fabricated brazing sheet products produced via a hot roll, bonding technology;

FIG. 3 is a table (Table 2) showing the pre-braze and post-braze mechanical properties of the laboratory-fabricated brazing sheet products produced via the hot roll bonding technology and summarized in Table 1;

FIG. 4 is a table (Table 3) showing the compositions (wt-%) of the plant-produced brazing sheets produced via the hot roll bonding technology; and

FIG. 5 is a table (Table 4) showing the pre-braze and post-braze mechanical properties data for the plant-produced brazing sheets produced via the hot roll bonding technology and summarized in Table 3.

### DETAILED DESCRIPTION OF PREFERRED EMBODIMENTS

All elemental concentrations in the alloys herein are by weight percent unless otherwise indicated. As used herein, the term “substantially free” means that no purposeful addition of that alloying element was made to the composition, but that, due to impurities and/or leaching from contact with manufacturing equipment, trace quantities of such elements may, nevertheless, find their way into the final alloy product. In addition, when referring to any numerical range of values, such ranges are understood to include each and every number and/or fraction between the stated range minimum and maximum. A range of about 5 to 15 wt-% silicon, for example, would expressly include all intermediate values of about 5.1, 5.2, 5.3 and 5.5 wt-%, all the way up to and including 14.5, 14.7 and 14.9 wt-% Si. The same applies to each other numerical property, relative thickness, and/or elemental range set forth herein.

The metallurgical approach to the core alloy is as follows. It has been found that one of the keys to the development of a microstructure that is highly resistant to recrystallization during the brazing cycle of brazing sheet manufacturing is the presence of a significant volume-fraction of fine particles, e.g., dispersoids. The Zener drag pressure exerted by a dispersoid population on a boundary is inversely proportional to the mean diameter of the particles and/or dispersoids and is directly proportional to their volume-fraction. As a result, it is believed that, for any given deformation state, there exists a critical particle diameter above which the particle can serve as a potential nucleation site for recrystallization. In most commercial dispersion-strengthened alloys, there is a population of particles and/or dispersoids above and below this critical mean diameter. Those particles above the critical diameter serve as potential nucleation sites for recrystallization and those below retard grain growth and inhibit recrystallization. Hence, if the goal is to inhibit recrystallization, the ideal microstructure is one which exhibits a high volume-fraction of fine sub-critical particles with high Zener drag, but which contains a minimal number of particles above the critical diameter for the alloy in tire deformation state of interest. Ideally, these dispersoids should be stable (i.e., insoluble or minimally soluble) in the core alloy during the brazing cycle employed to braze the part. Elements such as Zr, V, Cr and Ti promote the formation of small dispersoids and inhibit recrystallization to varying degrees, and, as such, are generally desirable at low concentrations in the core alloys of the invention. Particles of Al_{V}Mn_{W}Si_{X}Fe_{Y}Ni_{Z}, if present, also can inhibit recrystallization, particularly if a significant volume-fraction of them are small, e.g., less than about 1 micron diameter. It should be expressly noted that the Mn, Si, Fe and Ni concentrations in the Al_{V}Mn_{W}Si_{X}Fe_{Y}Ni_{Z} particles can vary over a wide range of stoichiometrics or can be fully absent from the particles, depending on the alloying levels present in the alloy.

Si concentrations above approximately 0.1 wt-% generally result in increasing volume-fractions of Al_{V}Mn_{W}Si_{X}Fe_{Y}Ni_{Z} particles which are highly resistant to reversion during the brazing cycles. It is generally preferable to eliminate, or at least minimize, exposure of the core alloy to high temperature thermal treatments (e.g., homogenization, extended exposure to reheat for hot rolling, etc.) during the production of the brazing sheet to keep the highest possible volume-fraction of small dispersoids. Likewise, high solidification rates during casting are desirable because they allow for the introduction of higher volume-fractions of fine dispersoids into the alloy. As such, thin ingots are more desirable than thicker ingots for Direct-Chill casting of core alloys.

The compositions and processing routes for the core alloys ideally should be selected to generate a high volume-fraction of fine (<1 micron average diameter) particles to make the core alloy resistant to recrystallization during the brazing cycle. Desirable core alloys include 3xxx alloys with Si concentrations above 0.1 wt-%, especially those with high Mn concentration (>0.8 wt-%) and with Si concentrations above 0.5 wt-%. Additions of known recrystallization inhibitors like Zr are also desirable.

This same metallurgical approach can be used for selecting the outerliner alloys in the variants of the invention incorporating an outerliner. An outerliner would be employed if the design of the heat exchanger was such that the one face of the sheet required an alloy whose material characteristics were specifically tailored to its working environment. For example, since the working environment for an evaporator heat exchanger usually is damp and prone to promote corrosion, the outerliner for an evaporator heat exchanger component preferably would consist of an alloy with a high resistance to corrosion.

The core aluminum alloy composition must fall within a range of compositions such that the net concentration of the solute participating in the formation of dispersoids is higher than the net concentration of the solute that does not generally form dispersoids. Preferably, this results in the following relationship holding true:

$$( \frac{Mn + Fe + Ti + Cr + V + Zr + Ni}{Si} ) - ( \frac{Cu + Mg + Zn}{Si} ) \geq 0 \qquad ( equation 1 )$$

Furthermore, it is preferred that the (Mn+Fe)-to-Si ratio in the core alloy be greater than or equal to about 1.5. Note, all alloy concentration values are expressed in wt-%.

It should be noted expressly that some of the above alloying elements can be at low, impurity levels, at undetectable levels, or altogether absent, as long as the relationship described above in equation 1 holds true and as long as a significant population of particles are fine particles. Given cost and general scrap loop considerations, alloying elements like Ni, Cr, and V are typically disfavored, but are perfectly suitable for use in this invention. The thickness of the core alloy at final clad composite gauge can be as little as about 100 microns to as much as about 9 mm.

The 4xxx cladding alloys should contain between about 4 and about 17 wt-% Si, between about 0.01 and about 1 wt. % Fe, up to about 2 wt. % Mg, up to about 2 wt. % Zn, up to about 0.5 wt. % Cu and up to about 0.5 wt. % Mn, up to about 0.2 wt. % In, with the balance of incidental elements and impurities being each at 0.05 wt. % or less, and not more than 0.25 wt. %, combined. The actual compositions will depend on the brazing application and electrochemical potential desired in the cladding alloy. Particularly suitable 4xxx cladding alloys will contain between 6 and 13 wt. % Si, less than 0.5 wt. % Fe, less than 0.15 wt. % Mn, and less than 0.3 wt. % Cu, with the Mg concentrations dependent upon and tailored to the brazing method being employed (vacuum or flux-brazed), and the Zn and/or In concentration tailored to effect a desired electrochemical potential within and adjacent to the brazing joint. It should also be noted that, in products requiring that both outer surfaces be clad with 4xxx alloys, the most typical application would have similar 4xxx alloys; however, the selection of the 4xxx cladding alloy is dependent on the brazing method employed and the design of the final part being brazed. The thickness of the 4xxx cladding alloys can range from as little as about 15 microns to about 250 microns at the final gauge of the clad product.

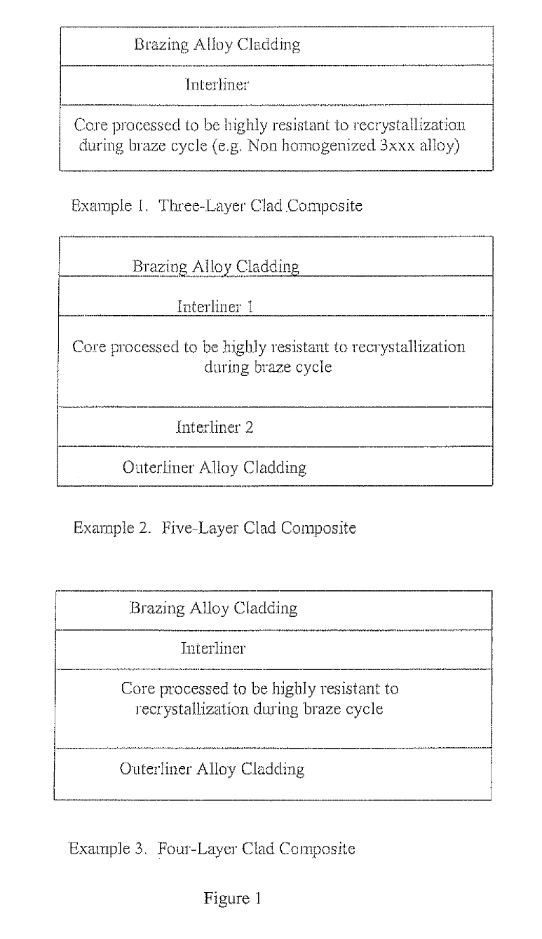

The material concepts depicted in FIG. 1 could be fabricated via traditional roll bonding technologies or alternatively by any known method of casting multi-layer ingots including the Simultaneous Multi-Alloy Casting (SMAC) technology in which the interlayer(s) can be introduced as solid plates onto which the adjoining layers are cast, or the Unidirectional Solidification of Casting (USoC) technology in which each layer, including interlayer(s) would be cast sequentially as the ingot is cast from one rolling surface to the other rolling surface, both multi-alloy casting processes discussed further below.

The outerliner layer as depicted in FIG. 1, (e.g., in variant 3) would generally be an alloy tailored to provide high corrosion resistance in the environment to which that face of the sheet is exposed and/or an alloy with elevated Mg concentration (relative to the core alloy) to provide even higher strength, if the application, part design, and brazing process were allowed. One typical, consideration in the claimed compositions is that the composition of the outerliner alloy be such that the Mg and/or Zn concentration be greater than that of the core alloy chosen for the specific application. This alloy should also have a solidus value in excess of 550° C., preferably above 580° C. At final brazing sheet gauge, the outerliner should be at least about 1.5 microns thick, preferably between about 15 and about 350 microns in thickness.

One embodiment of the outliner layer is disposed adjacent to an opposing side of the non-homogenized core. The outerliner layer can have a composition comprising Si between about 0.1 and 1.2 wt. %, Fe concentration below about 1 wt. %, Mg concentration between about 0.5 and about 2 wt. %, Zn concentration less than about 5 wt. %, Cu concentration below 0.5 wt, %, and Mn concentration less than 1.7 wt. %.

Another embodiment of the outerliner layer is an aluminum alloy with Mg concentration below 0.5 wt. %, Fe concentration below about 0.8 wt. %, Cu concentration below about 0.5 wt. %, Mn concentration below about 1.7 wt. %, Cr concentration below about 0.3 wt. %, Zn concentration between 0 and about 1.5 wt. %, and Zr concentration below about 0.3 wt. %.

For many applications, it may be desirable for the aluminum producer to provide the brazing sheet product in a non-fully-annealed temper to obtain the full benefit of strengthening in the post brazed part. The summation of strain imparted into the material at both the aluminum brazing sheet producer and the part fabricator must be less than the critical amount of strain needed for complete recrystallization in the core alloy of the invention after brazing to receive some benefit from the strengthening associated with a recovered microstructure. As such, various tempers may be purposefully developed for brazing sheet material destined for specific parts to be fabricated from the brazing sheet to maximize post-braze yield strength within said part.

FIG. 1 depicts various possible combinations of core, claddings, and interliners. As depicted, the brazing sheet product may be comprised of three, four, or five distinct layers. One of the outer layers for the three-layer products would be a 4xxx alloy cladding. The four- and five-layer products would have at least one 4xxx alloy outer layer, but perhaps two, 4xxx alloy outer layers. The interliner, resistant to erosion, is bonded between the core and the 4xxx alloy cladding and/or between the core and the outerliner. Wherein the multi-layer product can be partially or completely fabricated using any multi-alloy casting process including but not limited to Simultaneous Multi-Alloy Casting (SMAC) (as described in U.S. Pat. No. 6,705,384, which is incorporated herein by reference), wherein, for example, the interliner(s) is (are) the divider sheet(s) or plate(s) employed to separate the molten metal streams during casting) and which is subsequently rolled to gauge.

One example of a multi-layered metal ingot embodiment is fabricated by the Simultaneous Multi-Alloy Casting (SMAC) process includes the steps of delivering a metallic divider member into a modified direct chill mold, pouring a first molten metal into the mold on one side of the divider member and pouring a second molten metal into the mold on the other side of the divider member, and allowing the first molten metal and the second molten metal to solidify to form a metal ingot which includes the divider metal layer disposed between the two cast layers. The multi-layered metal ingot removed from the mold contains at least two cast layers including the first and second metals separated by a layer of the divider member. Alternatively, the divider member may be positioned against a wall of the mold and a single molten, metal is poured into the mold to produce one cast layer bound to the divider member thereby forming an outer shell or cladding on the ingot. The divider member may be a sheet having a thickness of up to about 0.25 inch or a plate having a thickness of up to about 6 inches. The position of the divider member may be shifted within the mold to produce varying thicknesses of the cast metals. More than one divider member may be placed in the mold with molten metals poured on opposite sides of each divider member to produce a metal product having at least three cast layers separated by the divider members. The fundamental principles guiding the attainment of a strongly bonded interface between the divider member and the molten metal are identical regardless of where the divider member is located within the ingot.

The molten metals may each be an alloy of AA series 1000, 2000, 3000, 4000, 5000, 6000, 7000, or 8000. The divider member should be a solid metal that will survive exposure to the molten aluminum during the casting operation. For the purpose of maintaining a “clean” scrap loop, the divider member preferably is aluminum or an aluminum alloy or a clad aluminum product that has a solidus temperature greater than the liquidus temperatures of the alloys cast on either side thereof. It is preferred that the solidus temperature of the divider member be at least 610.degree. C. A particularly suitable metal for the divider member is tin AA 1000 series alloy.

The ability to achieve high post-braze strength relies on the use of a non-homogenized, high-Si (>0.2 wt-%) 3xxx alloy core, separated from the 4xxx alloy braze cladding(s) by an interliner. Again, because non-homogenized 3xxx alloy cores (that recover) are sensitive to core erosion (localized melting of the core alloy in contact with the molten 4xxx cladding) during brazing, 3xxx core alloys typically are homogenized for products requiring significant formability (generally those products requiring O-temper). Homogenization (a high temperature [>450C] thermal treatment for more than about 3 hrs) generally improves formability. Core erosion generally is deleterious to corrosion resistance and cladding flow (i.e., brazeability). The use, under the patent, of an interliner protects the non-homogenized core alloy from coming into contact with the molten 4xxxx alloy cladding during the brazing process. In this way, use of a recovered microstructure with a high volume-fraction of fine Al_{W}Mn_{X}Si_{Y}Fe_{Z} particles is possible. Furthermore, by selecting a high-Si 3xxx core alloy, the AlMnSiFe particles do not revert during the brazing process. As such, these fine particles are able to help inhibit recrystallization and promote a recovered, rather than recrystallized, microstructure. This recovered microstructure has significantly higher TYS and UTS values, while maintaining good formability. This approach has allowed for post-braze TYS values in excess of 85 MPa and post-braze UTS values in excess of 160 MPa, even in Mg-free alloys. The foregoing TYS compares favorably to a maximum TYS of about 68 MPa for the same core alloy in the homogenized condition. If the brazing process and the part/joint geometry can tolerate higher Mg concentrations in the core alloy, higher post-braze properties are possible with Mg additions to the core alloy.

One embodiment of a corrosion resistant interliner includes a microstructure having course grain size or capable of recrystallizing to course grain structure. One example of a course grain microstructure includes an average grain size equal to or greater than 150 μm.

In an alternative embodiment, the aluminum alloy interliner can have an equilibrium solidus temperature equivalent to or higher than an equilibrium solidus temperature of the non-homogenized core.

One embodiment of the aluminum alloy interliner is a 3XXX series alloy.

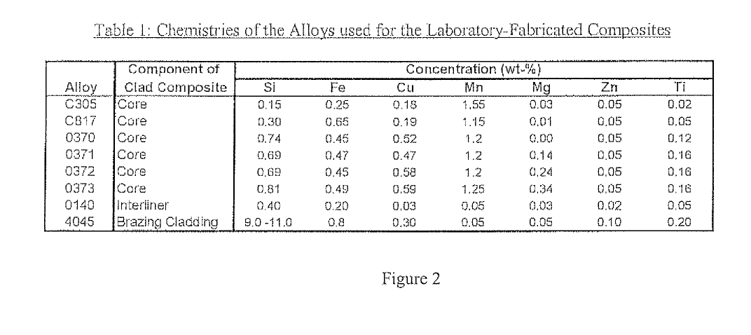

FIG. 2 (Table 1) is a table of the compositions of the alloys used in the various laboratory-fabricated composites evaluated in this study.

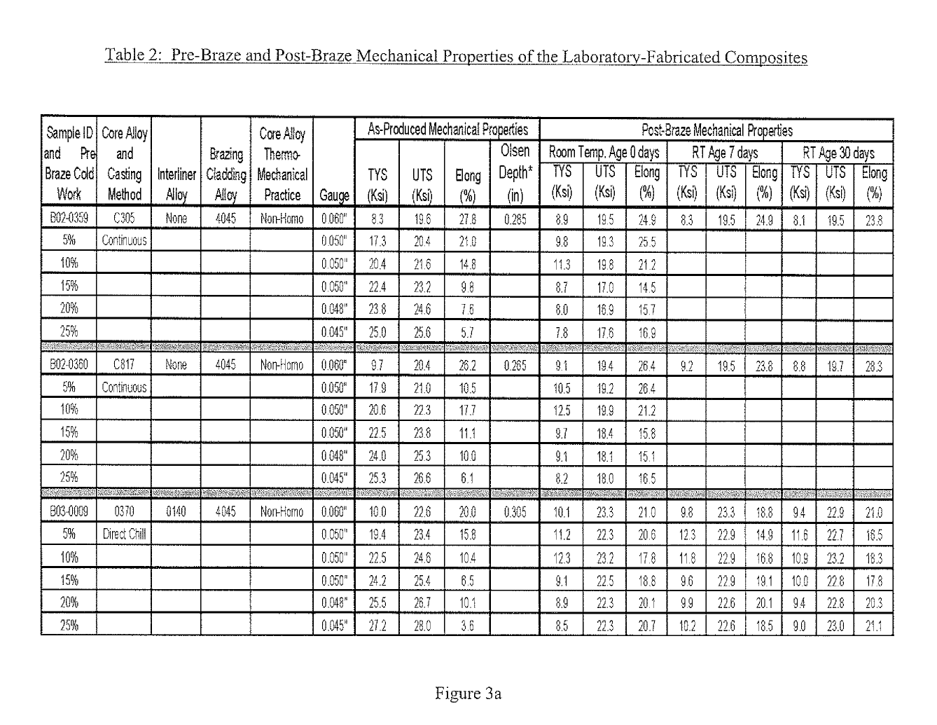

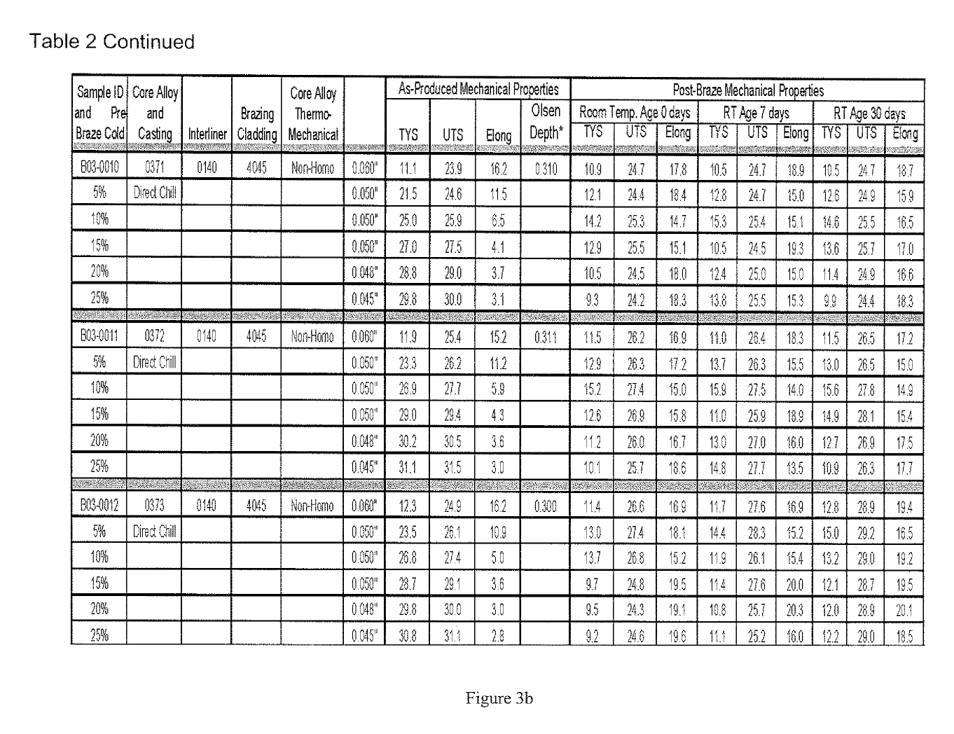

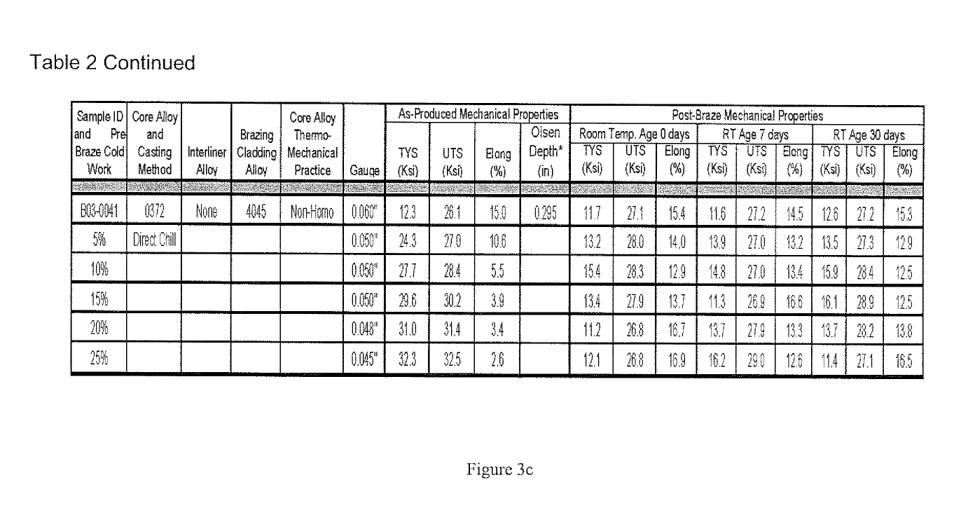

FIG. 3 (Table 2) is a table of pre-braze and post-braze mechanical properties for the laboratory-fabricated composites, as a function of applied pre-braze cold work. The composite materials were fabricated in the laboratory using a hot-roll bonding technology. The hot-roll bonding technology fabrication path used to generate the composition material used in FIG. 3 is anticipated to generate properties similar to those that would be realized by multi-layer composites generated according to a multi-layer casting process such as SMAC or USoC.

Samples of later hot-roll, bonded plant-produced variants consisting of a core, an interliner, and a cladding of 4045 alloy were tested in the as-produced condition and after having been plastically stretched 5%, 10%, 1.5%, and 20%. As used herein, a sample stretched X % means that, after stretching, the sample is 100%+ X % of the original length.

FIG. 4 (Table 3) displays the alloy compositions and their functions in the plant-produced clad composites used in this study.

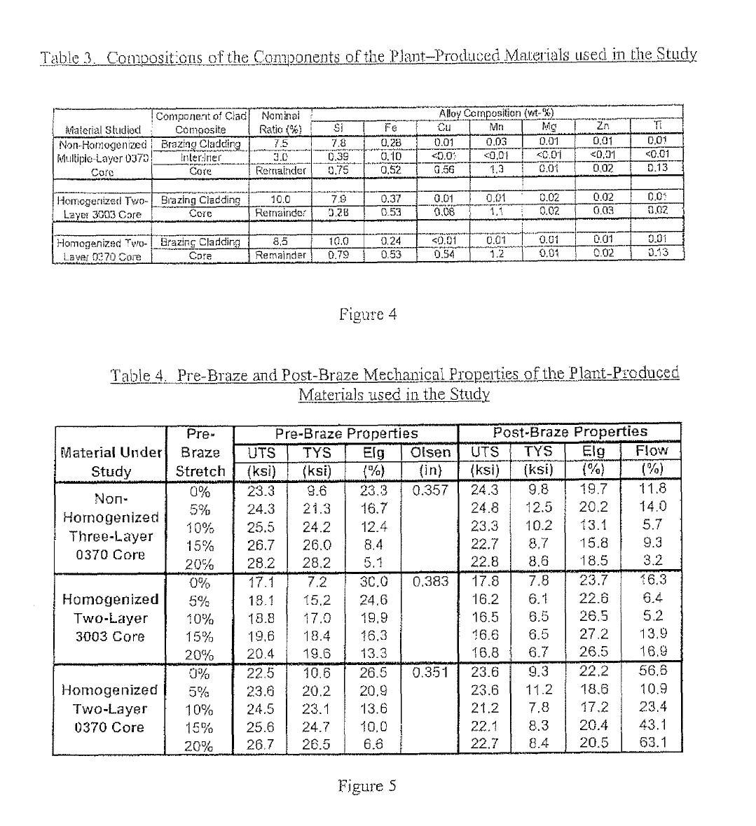

FIG. 5 (Table 4) presents pre-braze and post-braze mechanical properties for the plant-produced materials used in this study. All the mill processing was controlled to generate materials that are anticipated to generate properties similar to multi-layer composites generated in whole or in part via a multi-layer ingot casting technology.

Another embodiment of the present invention is that any of the materials described above and shown in FIG. 1 can be partially or completely fabricated from, an alternative multi-layer ingot cast process entitled Unidirectional Solidification of Castings, disclosed in U.S. Pat. No. 7,264,038 and U.S. patent application Ser. No. 11/484,276, both incorporated by reference herein. In this case the interliner layers would be cast into the multilayer ingot instead of being introduced as solid plates as in SMAC or by cladding multiple solid plates together as is done in traditional roll-bonding. In the Unidirectional Solidification of Casting process the rate at which molten metal flows into the mold, and the rate at which coolant is applied to the mold, are both controlled to provide a relatively constant rate of solidification. The coolant may begin as air, and then gradually be changed from air to an air-water mist, and then, to water. The unidirectionally solidifying castings provide a uniform, solidification rate, thereby providing a casting having a uniform microstructure and lower internal stresses. This process can provide for substantially all the critical metallurgical and process requirements necessary to generate the multi-layer ingot structure. In this case multiple molten metal alloy streams would be directed to the casting zone and alternately fed into the mold to produce an ingot with layers of different composition. The multi-layer ingot from this casting operation can be processed in the mill similar to a monolithic ingot, using all the standard process steps of scalping, reheating, hot-rolling, cold rolling, and annealing. As with Simultaneous Multi-Alloy Casting (SMAC), the Unidirectional Solidification of Castings process overcomes the problems associated with having to bond the various layers in the hot mill by casting them together into a single multi-layer ingot with the appropriately positioned and sized layers of each of the various alloys. This process provides another way of fabricating the multi-layer structure necessary for fabricating the high strength material.

One example of a multi-alloy ingot embodiment fabricated by the Unidirectional Solidification of Castings process includes a mold oriented substantially horizontally, having four sides and a bottom that may be structured to selectively permit or resist the effects of a coolant sprayed thereon. One example of the bottom is a substrate having holes of a size that allow coolants to enter but resist the exit of molten metal. Such holes can be at least about 1/64 inch in diameter, but not more than about one inch in diameter. Another example of the bottom is a conveyor having a solid section and a mesh section. Other bottoms include bottoms structured to be removed from the remainder of the mold upon solidification of the molten metal on the bottom of the mold, with a mesh, cloth, or other permeable structure remaining to support the casting. A trough for transporting molten metal from the furnace terminates at one side of the mold, and is structured to transport metal from the furnace or other receptacle to a molten metal feed chamber disposed along one side of the mold. The molten metal feed chamber and mold are separated from each other by one or more gates. An example of a gate is a cylindrical, rotatably mounted gate, defining a helical slot therein, so that as the gate rotates, molten metal is released horizontally into the mold, only at the level of the top of the molten metal within the mold. Another example of the gate is merely slots at different heights in the wall separating the mold and feed chamber, so that the rate at which molten metal is added to the feed chamber determines the rate and height at which molten metal enters the mold. Another example of the gate is a flow passage between the molds and the feed chamber having a vertical slider at each end, so that the vertical slider resists the flow of molten metal through a slot in both the mold and the feed chamber, while permitting the flow of molten metal through the channel. The flow of molten metal is thereby limited to a desired height within the mold, set by the height of the channel. In some embodiments, a second trough and molten metal feed chamber may be provided on another side of the mold, thereby permitting a second alloy to be introduced into the mold during casting of a first alloy, for example, to apply a cladding to a cast item. The sides of the mold are preferably insulated. A plurality of cooling jets, for example, air/water jets, will be located below the mold, and are structured to spray coolant against the bottom surface of the mold.

One embodiment of the multi-alloy metallurgical product is age-harden able after exposure to a brazing cycle.

One example of a multi-layered metal ingot embodiment fabricated by the Unidirectional Solidification of Castings process includes the molten metal being introduced substantially uniformly through the gates. At the same time, the cooling medium is applied uniformly over the bottom area of the mold. The rate at which molten metal flows into the mold, and the rate at which coolant is applied to the mold, are both controlled to provide a relatively constant rate of solidification. The coolant may begin as air, and then gradually be changed from air to an air-water mist, and then to water. Typically, the cooling rate will remain between about 0.5 degree F./sec. to about 3 degree F./sec, with the cooling rate typically decreasing from 3 degree F./sec. at the beginning of casting to about 0.5 degree F./sec. towards the completion of casting. Likewise, the rate at which molten metal is introduced into the mold cavity will typically be slowed from an initial rate of about 4 in./min. to a final rate of 0.5 in./min. as casting progresses. After the molten metal at the bottom of the mold solidifies, the bottom of the substrate may be moved so that the solid section underneath the mold is replaced by the mesh section, thereby permitting the coolant to directly contact the solidified metal, and maintain a desired cooling rate. In the case of the perforated plate substrate, the mold bottom need not be removed. In some embodiments, a second trough and molten metal feed chamber may be provided on another side of the mold, thereby permitting a second alloy to be introduced into the mold during casting of a first alloy, for example, to apply a cladding to a cast item. This procedure may be extended to make a multiple layer ingot product having at least two different alloy layers. The different alloys are fed into the casting zone and sequentially solidified through the thickness of the ingot being cast. In this way the multi-layer ingot is generated by casting all the layers into one ingot. For a complete discussion of the embodiments and processes for Unidirectional Solidification of Castings see U.S. Pat. No. 7,264,038 and U.S. patent application Ser. No. 11/484,276, both incorporated herein by reference.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

1. A multi-alloy metallurgical product comprising:
a non-homogenized core comprising of an Aluminum Association 3xxx series alloy having a (Mn+Fe) to Si ratio greater than about 1.4, the non-homogenized core having Al—Mn—Si—Fe—Ni particles being less than about 1 micron in average diameter, wherein the solute (in weight percent) of the non-homogenized core satisfies the following equation: ((Mn+Fe+Ti+Cr+V+Zr+Ni)/Si)−((Cu+Mg+Zn)/Si)>0;
a 4xxx cladding alloy; and
an aluminum alloy interliner disposed between the non-homogenized core and the 4xxx cladding alloy, the aluminum alloy interliner having a microstructure resistant to localized erosion,
wherein the multi-alloy metallurgical product is partially or completely fabricated via a process that involves casting a multi-layer ingot including but not limited to unidirectional solidification of castings process or a simultaneous multi-alloy casting process.

2. The multi-alloy metallurgical product of claim 1, wherein the non-homogenized core comprises an Aluminum Association 3XXX series alloy comprising greater than about 0.1 wt. % Si.

3. The multi-alloy metallurgical product of claim 1, wherein the non-homogenized core comprises between about 0.5 wt. % and about 1.7 wt. % Mn, between 0.1 wt. % and about 1.2 wt. % Si, less than about 2 wt. % Fe, less than about 2.5 wt. % Mg, less than about 1.2 wt. % Cu, less than about 3 wt. % Zn, between 0 and about 0.3 wt. % Ti, less than about 0.3 wt. % Zr.

4. The multi-alloy metallurgical product of claim 1, wherein the non-homogenized core comprises an Aluminum Association 3XXX series alloy comprising a Mn concentration greater than about 0.8 wt. % and a Si concentration greater than about 0.5 wt. %.

5. The multi-alloy metallurgical product of claim 1, wherein the non-homogenized core has purposeful additions of up to about 0.3 wt % Zr to inhibit recrystallization.

6. The multi-alloy metallurgical product of claim 1, wherein the non-homogenized core has a thickness of about 100 microns to about 9.0 mm.

7. The multi-alloy metallurgical product of claim 1, wherein the interliner is an aluminum alloy comprising about 0.4 wt. % Si and up to about 0.20 wt. % Fe.

8. The multi-alloy metallurgical product of claim 1, wherein the interliner is a 1xxx alloy.

9. The multi-alloy metallurgical product of claim 1, wherein the interliner alloy is sacrificial electrochemically to the non-homogenized core.

10. The multi-alloy metallurgical product of claim 1, wherein the final gauge of the sheet is less than 9 mm.

11. The multi-alloy metallurgical product of claim 1, wherein the 4xxx braze cladding comprises about 4.0 wt. % to about 17.0 wt. % Si, about 0.01 wt. % to about 1.0 wt. % Fe, up to about 0.5 wt. % Mn, up to about 0.5 wt. % Cu, up to about 2.0 wt. % Zn, up to about 2.0 wt. % Mg, and up to about 0.2 wt. % In.

12. The multi-alloy metallurgical product of claim 1, wherein the 4xxx braze cladding comprises between about 6 wt. % and about 13 wt. % Si, less than about 0.5 wt. % Fe, less than about 0.15 wt. % Mn, and less than about 0.3 wt. % Cu.

13. The multi-alloy metallurgical product of claim 1, wherein the 4xxx braze cladding has a thickness of about 15 microns to about 250 microns.

14. The multi-alloy metallurgical product of claim 1, wherein an opposing side of the non-homogenized core is adjacent to an outerliner layer with a composition comprising Si between about 0.1 and 1.2 wt. %, Fe concentration below about 1 wt. %, Mg concentration between about 0.5 and about 2 wt. %, Zn concentration less than about 5 wt. %, Cu concentration below 0.5 wt. %, and Mn concentration less than 1.7 wt. %.

15. The multi-alloy metallurgical product of claim 1, wherein the metallurgical product is a brazing sheet product in “O” temper.

16. The multi-alloy metallurgical product of claim 1, wherein the product is age-hardenable after exposure to a brazing cycle.

17. The multi-alloy metallurgical product of claim 1, wherein the brazing sheet product is used in a heat exchanger.

18. The multi-alloy metallurgical product of claim 1, comprising a post braze tensile yield strength (TYS) of greater than about 85 MPa and an ultimate tensile strength (UTS) of greater than about 160 MPa.

19. The multi-alloy metallurgical product of claim 1, further comprising an outerliner layer adjacent a side of the non-homogenized core opposing the aluminum alloy interliner and 4xxx cladding alloy, wherein the outerliner layer comprises an alloy comprising a composition including Mg or Zn in a concentration above that of the non-homogenized core and a solidus temperature above about 550° C.

20. The multi-alloy metallurgical product of claim 19, wherein the outerliner layer is an aluminum alloy with Mg concentration below 0.5 wt. %, Fe concentration below about 0.8 wt. %, Cu concentration below about 0.5 wt. %, Mn concentration below about 1.7 wt. %, Cr concentration below about 0.3 wt. %, Zn concentration between 0 and about 1.5 wt. %, and Zr concentration below about 0.3 wt. %.

21. The multi-alloy metallurgical product of claim 19, wherein a thickness of the outerliner layer is between about 15 microns and about 350 microns.

22. The multi-alloy metallurgical product of claim 19, further comprising a second interliner being disposed between the outerliner layer and the non-homogenized core.

23. The multi-alloy metallurgical product of claim 1, wherein the aluminum alloy interliner comprises an equilibrium solidus temperature equivalent to or higher than an equilibrium solidus temperature of the non-homogenized core.

24. The multi-alloy metallurgical product of claim 1, wherein the aluminum alloy interliner is a 3XXX series alloy.

25. The multi-alloy metallurgical product of claim 14 further comprising a second interliner being disposed between the outerliner layer and the non-homogenized core.

26. The multi-alloy metallurgical product of claim 1 wherein the interliner microstructure comprises course grains.

27. The multi-alloy metallurgical product of claim 26 wherein the course grains comprise an average grain size equal to or greater than 150 μm.

28. The multi-alloy metallurgical product of claim 1 wherein the Al—Mn—Si—Fe—Ni particles being less than about 0.1 microns in average diameter.
